(19) United States
(12) Patent Application Publication
(10) Pub. No.: US 2003/0081120 A1
(43) Pub. Date: May 1, 2003

(54) Method and system for providing power and signals in an audio/video security system

(76) Inventor: Steven Klindworth, Liberty Hill, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/016,594

(22) Filed: Oct. 30, 2001

(51) Int. Cl. H04N 7/18

(52) U.S. Cl. 348/143

(57) ABSTRACT

The invention provides a system and method for processing one or more audio/video sources for connection to a video monitor and speaker, utilizing a single coaxial cable between each remotely located audio/video source and a processing means. It provides a simultaneous or sequential display of one or more remotely located video sources and annunciation of one or more remotely located audio sources. The processing means and the audio/video sources include a splitter and combiner to separate and combine, respectively, an audio/video modulated carrier from DC power. The processing means and the video source may contain a switch for selecting power from the coaxial cable or from a local power source. By requiring only a single coaxial cable between each video source and the processing means, cable installation is greatly simplified.

### BACKGROUND

The invention relates generally to the field of security systems and more particularly to a method and system for providing power and signals over a single coaxial cable between remote surveilled locations and a central monitoring location.

The technical development of charge-coupled-devices (CCDS) has enabled video cameras to be manufactured that are very small and inexpensive. Compared to the large complex cameras used in television studios, these cameras are compact, light weight and have low power consumption requirements, but lack the high quality image producing capabilities of their television studio counterparts. One of the most widely used applications for these small lightweight cameras is in security surveillance systems.

Over the last several years, the use of video security surveillance cameras has rapidly increased. These video cameras are used in a variety of locations for various purposes, and are frequently connected through a switcher or processor to a display in a central monitoring location for periodic observation. Security surveillance video cameras are often installed to monitor distant remote locations. The typical surveillance arrangement includes several remote cameras with microphones connected to a central viewing location where the signal from the cameras can be monitored. It is frequently difficult and costly to supply power at these locations. Also, installing security/surveillance cameras in distant remote locations is made more difficult in that they often require the installation of several separate cables for power, audio signal, and video signal over long distances.

In the past, a plurality of coaxial cables were used for carrying signals and power was supplied to cameras by a portable power generator, conventional drop cords connected to the nearest A.C. outlet, or dedicated power wiring. These cabling techniques are expensive, heavy and difficult to install. In addition, most cameras also require an independent power supply at the remote location to supply D.C. power to the video sources. In practice, the cost of installing cables and wiring often exceeded the cost of audio and video equipment.

It is desirable to enable DC power, audio signals and video signals to be supplied between remote security surveillance locations and a central control location through a single coaxial cable. This would reduce the cost of installing a multitude of cables to each remote video camera location in the video security surveillance system. It would also facilitate supplying DC power to video cameras installed in distant remote locations and eliminate the need for a multiplicity of remote DC power supplies. This would reduce the cost and increase the convenience of installing security surveillance cameras and associated audio equipment.

### SUMMARY

The present invention provides a system and method for supplying DC power, audio signals and video signals through a single coaxial cable between a remote security surveillance location and a central control location. There may be audio and video signal sources at the remote location. The central control location may include a video switch or processor for selecting and processing one or more video and audio source signals from one or more remote locations for connection to a video monitor and speaker. The video sources are typically video cameras, but may comprise other video sources. Each connection between the selecting and processing means and a video and audio source comprises a single coaxial cable. This cable carries audio and video signals from the remotely located source to the selecting/processing means, and DC power from the selecting and processing means to the video source. The selecting and processing means and the video sources include a splitter to separate the video signal, audio signal and DC power. The selecting and processing means and the video source may contain a switch for selecting power from the coaxial cable or from a local power source. The video signal may represent either a color or black and white picture. Advantages of this invention include minimizing the number of cables between a selector means and an audio/video source, and eliminating the need for power availability at the location of the audio/video source. This results in minimizing the equipment and installation costs.

A method having features of the present invention comprises modulating a carrier signal with an audio signal and a video signal in a camera at a remote location, transmitting the carrier signal on the single coaxial cable to an audio/video processor located at a central control location, receiving and demodulating the carrier signal into an audio component and a video component in the audio/video processor for display and acoustic monitoring, transmitting power from the audio/video processor to the remotely located camera over the single coaxial cable, and receiving and regulating the power in the remotely located camera for powering electronic components within the remotely located camera. The steps of transmitting the carrier signal and transmitting power over the single coaxial cable are conducted simultaneously. The method may further comprise combining the power and the modulated carrier in the audio/video processor and splitting the power and the modulated carrier in the remotely located camera. The method may further comprise displaying the video component on a video monitor and annunciating the audio component on a speaker. The step of receiving and demodulating the carrier signal may comprise receiving and demodulating a plurality of carrier signals into a plurality of audio components and a plurality of video components in the audio/video processor for display and acoustic monitoring, and the step of transmitting power from the audio/video processor may comprise transmitting power from the audio/video processor to a plurality of remotely located cameras over a plurality of single coaxial cables whereby a single coaxial cable is connected to each camera. The method may further comprise displaying the plurality of video components sequentially on a video monitor and annunciating the plurality of audio components sequentially on a speaker. The method may further comprise displaying the plurality of video components simultaneously on a video monitor and annunciating the plurality of audio components simultaneously on a speaker. The method may further comprise selecting the power in the remotely located camera from a remotely located power supply positioned near the camera. The method may further comprise selectively disabling transmitting power from the audio/video processor to selected cameras. The video signal may represent either a black and white image or a color image.

In an alternate embodiment of the present invention, a system comprises means for modulating a carrier signal with an audio signal and a video signal in a camera at a remote location, means for transmitting the carrier signal on the single coaxial cable to an audio/video processor located at a central control location, means for receiving and demodulating the carrier signal into an audio component and a video component in the audio/video processor for display and acoustic monitoring, means for transmitting power from the audio/video processor to the remotely located camera over the single coaxial cable, and means for receiving and regulating the power in the remotely located camera for powering electronic components within the remotely located camera. The means for modulating a carrier signal may comprise an audio/video modulator for amplitude modulating the carrier signal with the video signal and frequency modulating the carrier signal with the audio signal. The means for demodulating the carrier signal may comprise an audio/video demodulator for amplitude demodulating the carrier signal for obtaining the audio component and frequency demodulating the carrier signal for obtaining the video component. The system may further comprise means for combining the power and the modulated carrier in the audio/video processor and means for splitting the power and the modulated carrier in the remotely located camera. The means for receiving and demodulating the carrier signal may comprise means for receiving and demodulating a plurality of carrier signals into a plurality of audio components and a plurality of video components in the audio/video processor for display and acoustic monitoring, and the means for transmitting power from the audio/video processor may comprise means for transmitting power from the audio/video processor to a plurality of remotely located cameras over a plurality of single coaxial cables whereby a single coaxial cable is connected to each camera. The system may further comprise a switch in the remotely located camera for selecting the power from a remotely located power supply positioned near the camera. The system may further comprise a plurality of switches in the audio/video processor for selectively disabling transmitting power from the audio/video processor to selected cameras.

In another embodiment of the present invention, a system comprises a plurality of remotely located cameras, each camera connected by a single coaxial cable to an audio/video processor at a central control location, a plurality of remotely located microphones, each microphone positioned in close proximity to and electrically connected to a remotely located camera, and the audio/video processor connected to a video monitor and a speaker, in addition to being connected to each of the plurality of cameras by a single coaxial cable. Each camera may comprise a video converter connected to a sender translator video input by a video connection and to a sender translator by a power connection through a switch, an external power supply connector connected to the switch, an external microphone connector connected to the sender translator microphone input, and a coaxial cable connector connected to the sender translator. The audio/video processor may comprise a plurality of coaxial connectors connected to a plurality of receiver translators, an audio output from each receiver translator connected to processing circuitry, a video output from each receiver translator connected to the processing circuitry, a power supply connected to the processing circuitry, the receiver translators, and to switches connected to the receiver translators for selectively enabling power transmission to remotely located cameras, a video monitor connector connected to the processing circuitry, and an audio speaker connector connected to the processing circuitry. The sender translator may comprise an audio level adjustment connected between the microphone input and an audio modulator input of an audio/video modulator, a video modulation adjustment connected between the video converter input and a video modulator input of the audio/video modulator, a voltage regulator with input connected to a splitter power output and output connected to the audio/video modulator and a video converter power connection, and the splitter connected to a coaxial cable connector for connecting to an audio/video processor, the splitter power output connection connected to the voltage regulator, and the splitter carrier signal input connected to a mixer output of the audio/video modulator. The audio/video modulator may comprise the audio modulator input connected to the audio level adjustment and an audio modulator output connected to a frequency generator, a frequency generator output connected to a mixer audio input, the video modulator input connected to the video modulation adjustment and a video modulator output connected to an input of a video carrier generator, a video carrier generator output connected to a mixer video input, and the mixer output connected to the splitter. Each of the receiver translators may comprise a connection between a coaxial cable connector and a combiner camera input, a power input connection between a power input connector, a voltage regulator input and a combiner power input, a voltage regulator output connected to an audio/video demodulator, a filter input connected to a combiner carrier signal output, a filter output connected to an input of an IF amplifier of the audio/video demodulator, an audio output driver having an input connected to the output of a sound detector of the audio/video demodulator and an output connected to an audio processing circuitry output, and a video output driver having an input connected to a video output of a video amplifier of the audio/video demodulator and an output connected to a video processing circuitry output. The audio/video demodulator may comprise an IF amplifier having the input connected to the filter output and an output connected to an input of a video demodulator, an output of the video demodulator connected to an input of the video amplifier, the video output of the video amplifier connected to the input of the video output driver and an audio output of the video amplifier connected to an input of an IF filter, an output of the IF filter connected to an input of a sound IF amplifier, and an output of the sound IF amplifier connected to the sound detector whose output is connected to the input of the audio output driver. The processing circuitry may generate a video monitor signal that is sent to the video monitor for sequential display of images from the plurality of cameras, and generates an audio speaker signal that is sent to the speaker for sequential annunciation of sound from the plurality of microphones synchronized with the monitor displayed images. The processing circuitry may also generate a video monitor signal that is sent to the video monitor for simultaneous display of images from the plurality of cameras, and generates an audio speaker signal that is sent to the speaker for selected annunciation of sound from one of the plurality of microphones.

### BRIEF DESCRIPTION OF THE DRAWINGS

These and other features, aspects and advantages of the present invention will become better understood with regard to the following description, appended claims, and accompanying drawings wherein:

FIG. 1 shows an example of a surveillance security system implementation according to the prior art;

FIG. 2 shows an embodiment of a surveillance security system implementation according to the present invention;

FIG. 3 shows an embodiment of an audio/video processor used in a surveillance security system according to the present invention;

FIG. 4 shows an embodiment of a remotely located camera and microphone used in a surveillance security system according to the present invention;

FIG. 5 shows an embodiment of a receiver translator used in an audio/video processor according to the present invention; and

FIG. 6 shows an embodiment of a sender translator used in a camera according to the present invention.

### DETAILED DESCRIPTION OF THE DRAWINGS

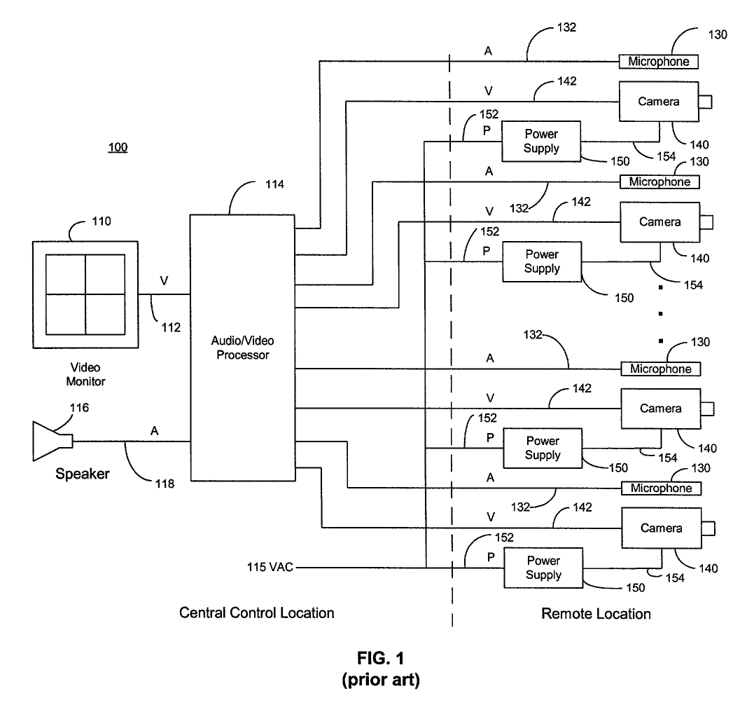

Turning now to FIG. 1, FIG. 1 shows an example of a surveillance security system implementation 100 according to the prior art. A plurality of cameras 140 and power supplies 150 are mounted in remote locations to provide fields of view of areas to be surveilled. The power supplies are connected to a 115VAC power cable 152 and to a camera 140 by a DC power cable 154. The remotely located cameras 140 are connected by a video cable 142 to a audio/video processor 114 located at a central control location. A plurality of microphones 130 may also be located in remote locations near an associated camera 140 and connected to the audio/video processor 114 by an audio cable 132. The audio/video processor 114 is also connected to a video monitor 110 by a cable 112 and to an audio speaker 116 by a cable 118.

The audio/video processor 114 is capable of sequentially selecting the video inputs from the plurality of cameras 140 for sequentially displaying the associated views on the video monitor 110. In a parallel manner, the audio/video processor 114 may also sequentially select the input from a microphone 130 associated with the camera 140 being selected for display, for transmitting the selected audio signal to the audio speaker 116. In an alternate mode of operation, the audio/video processor 114 may be programmed to select inputs from a multitude of cameras 140 for simultaneous display on the video monitor 110.

The installation of a plurality of remotely located microphones 130 and cameras 140 along with the associated power and signal wiring is a significant cost factor in many surveillance security systems. The cost of signal and power cable installation in many systems may exceed the equipment cost by significant amounts. This cost savings provides a strong incentive to determine means for reducing the cable installation costs.

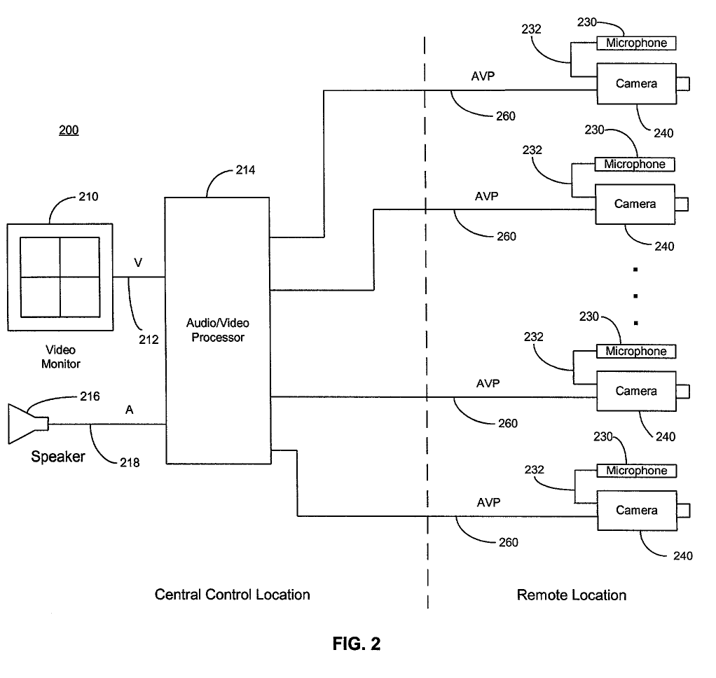

Turning now to FIG. 2, FIG. 2 shows an embodiment of a surveillance security system implementation 200 according to the present invention. A plurality of cameras 240 are mounted in remote locations to provide fields of view of areas to be surveilled. A plurality of microphones 230 may be associated with the cameras 240, and are connected to the associated cameras by audio cables 232. These audio cables 232 are generally short in length, since the microphone is associated closely with a camera 240. The remotely located cameras 240 are each connected by a single audio/video/power (AVP) cable 260 to an audio/video processor 214 located at a central control location. The AVP cable 260 is normally coaxial cable, but other appropriate cables may be used. A single coaxial AVP cable 260 carries a modulated audio and video signal from a camera 240 to the audio/video processor 214. In an alternate embodiment of the invention, a single coaxial AVP cable 260 carries a modulated video signal from a camera 240 to the audio/video processor 214. This same AVP cable 260 also conducts DC power from the audio/video processor 214 to the camera 240. Similar to the system implementation 100 shown in FIG. 1, FIG. 2 shows the audio/video processor 214 connected to a video monitor 210 by a video monitor cable 212 and to an audio speaker 216 by an audio speaker cable 218.

As in FIG. 1, FIG. 2 shows an audio/video processor 214 that is capable of sequentially selecting inputs from the plurality of cameras 240 for sequentially displaying the associated views on the video monitor 210. In a parallel manner, the audio/video processor 214 may also sequentially select the input from a microphone 230 associated with the camera 240 being selected for display, for transmitting the selected audio signal to the audio speaker 216. In an alternate mode of operation, the audio/video processor 214 may be programmed to select inputs from a multitude of cameras 240 for simultaneous display on the video monitor 210.

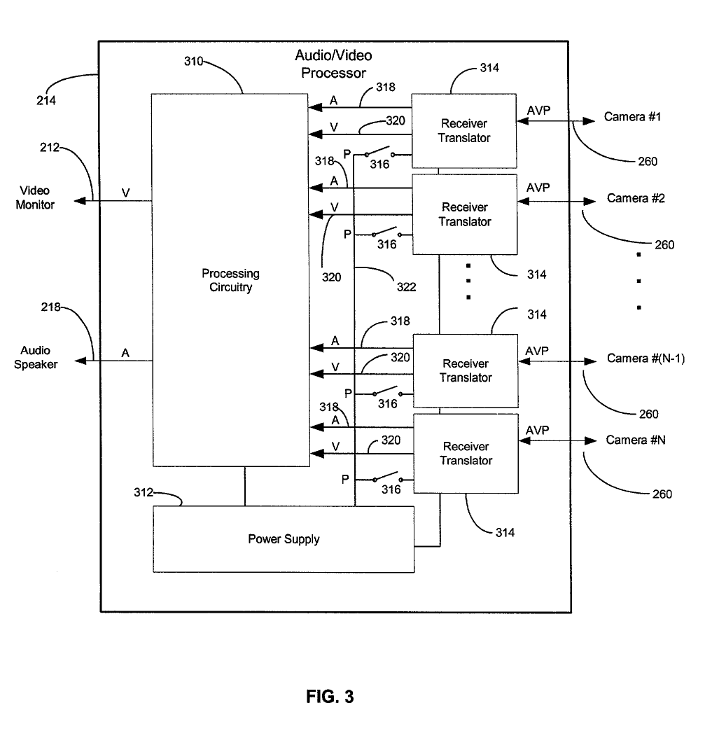

Turning now to FIG. 3, FIG. 3 shows an embodiment of an audio/video processor 214 used in a surveillance security system 200 according to the present invention. As described with reference to FIG. 2, the audio/video processor 214 is connected to a plurality of cameras 240 by AVP cables 260, to a video monitor 210 by a video monitor cable 212, and to an audio speaker 216 by an audio speaker cable 218. Within the audio/video processor 214, each of the AVP cables 260 connects to a receiver translator 314. The receiver translator 314 provides an audio signal 318 and a video signal 320 to processing circuitry 310. The processing circuitry 310 provides an output 212 to the video monitor 210 and an output 218 to the audio speaker 216. As described above, the processing circuitry 310 provides either sequential or simultaneous output displays on the video monitor 210 and the audio speaker 216. The audio/video processor 214 also contains a power supply 312 for powering the processing circuitry 310 and the receiver translators 314. Note that in the case where a standard video camera having a NTSC standard video output, or equivalent, is used to provide a signal 260 to the audio/video processor 214, the power that the receiver translators 314 normally sends down the AVP cable 260 to the camera is disabled by selectively opening switches 316. In this case, power is supplied to the standard video camera by a power supply positioned at the camera location. The opening of the switch 316 also causes the NTSC standard video signal to be connected directly to the processing circuitry, effectively bypassing the demodulator in the receiver translator. The processing circuitry 310 can generate a video monitor signal 212 that causes images from remotely located cameras to be sequentially displayed on a video monitor. The processing circuitry 310 can generate an audio speaker signal 218 that causes the sound from remotely located microphones to be sequentially annunciated by a speaker, synchronized with the sequential displayed images on the video monitor. The processing circuitry 310 can also generate a video monitor signal 212 that causes multiple images from remotely located cameras to be simultaneously displayed on a video monitor. The processing circuitry 310 can also generate an audio speaker signal 218 that causes the sound from selected remotely located microphones to be annunciated by the speaker.

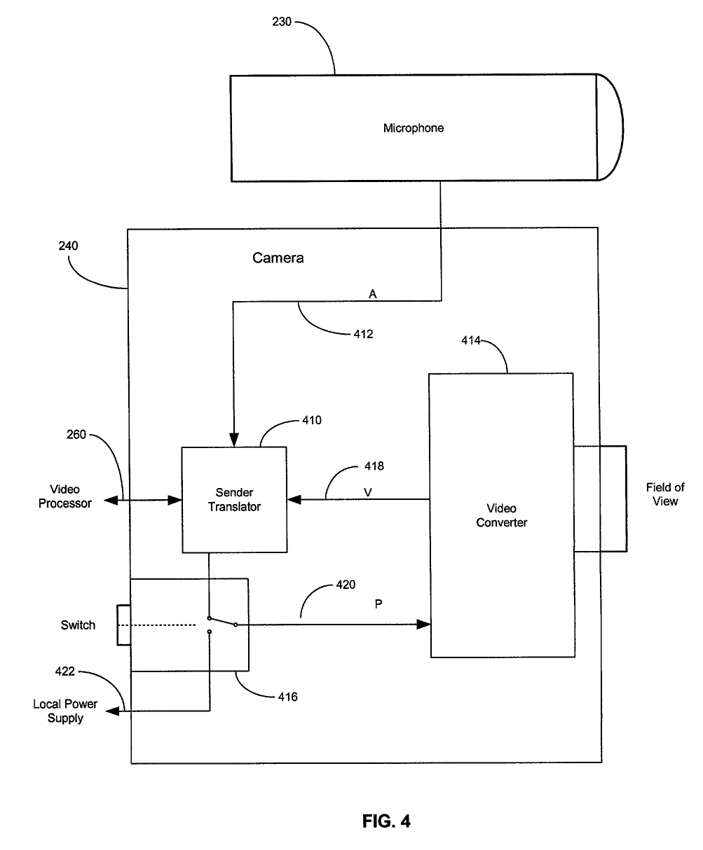

Turning now to FIG. 4, FIG. 4 shows an embodiment of a remotely located camera 240 and microphone 230 used in a surveillance security system according to the present invention. The camera 240 includes a video converter 414 for converting an image in the field of view of the video converter 414 into a video signal 418 that is sent to a sender translator 410. The video signal 418 may represent either a color image or a black and white image. The sender translator 410 also receives an audio signal 412 from a microphone associated with the camera 240. The sender translator 410 uses the audio signal 412 and the video signal 418 to modulate a carrier signal that is sent over an AVP cable 260 to a video processor. The sender translator 410 also receives DC power from the video processor that is regulated by the sender translator 410 and provided to the video converter 414 through switch 416. The switch 416 enables the power to the video converter 414 to be selected from either the sender translator 410 or a local power supply by a power cable 422.

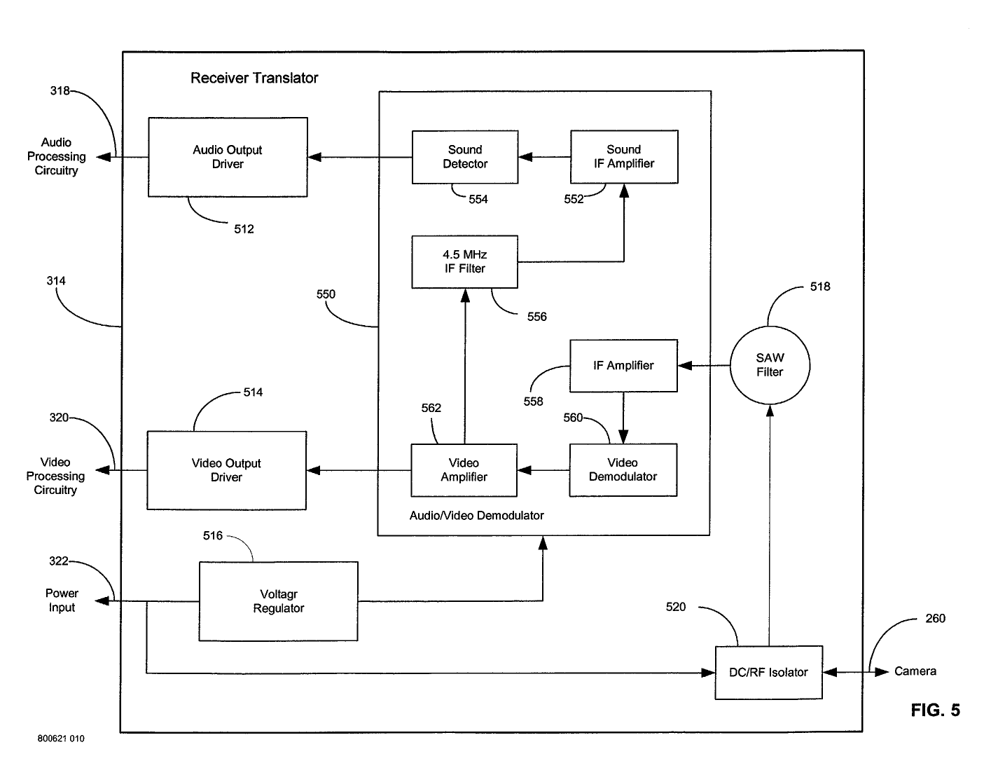

Turning now to FIG. 5, FIG. 5 shows an embodiment of a receiver translator 314 used in an audio/video processor according to the present invention. The receiver translator 314 is located in an audio/video processor and receives audio and video signals from a camera over a single coaxial cable 260. The same coaxial cable 260 is also used to send DC power to the camera. The receiver translator 314 processes the information from the camera 260 and sends an audio signal 318 to audio processing circuitry and a video signal 320 to video processing circuitry contained in the audio/video processor. The receiver translator makes use of an audio/video demodulator integrated circuit 550 to demodulate the audio and video signals from the camera. The signal received from the camera 260 includes a radio frequency carrier that is amplitude modulated by a video signal and frequency modulated by an audio signal. This modulated carrier is separated from the power on the coaxial cable by a DC/RF isolator 520 and passed through a surface acoustic wave (SAW) filter 518 to an intermediate frequency (IF) amplifier 558, and then to a video (amplitude) demodulator 560. The demodulated video signal is sent to a video amplifier 562. The output of the video amplifier 562 is sent to a video output driver 514 that provides a video signal 320 to processing circuitry. The output of the video amplifier 562 is also sent to a 4.5 MHz IF filter 556, a sound IF amplifier 552, and a sound detector 554 that demodulates the frequency modulated audio signal. The sound detector 554 sends an output signal to an audio output driver 512 that provides an audio signal 318 to the processing circuitry. The DC power provided to the receiver translator 322 is regulated by a voltage regulator 516 and used to power the audio/video demodulator 550. The DC power provided to the receiver translator 314 is also connected to an input of the DC/RF isolator 520, and the output of the combiner is connected to the coaxial cable 260. The DC/RF isolator 520 provides a high impedance power path to the power input to high frequency signals and a low impedance power path to DC power. Similarly, the DC/RF isolator 520 provides a low impedance carrier signal path for high frequency signals and a high impedance path for low frequency signals, including DC power.

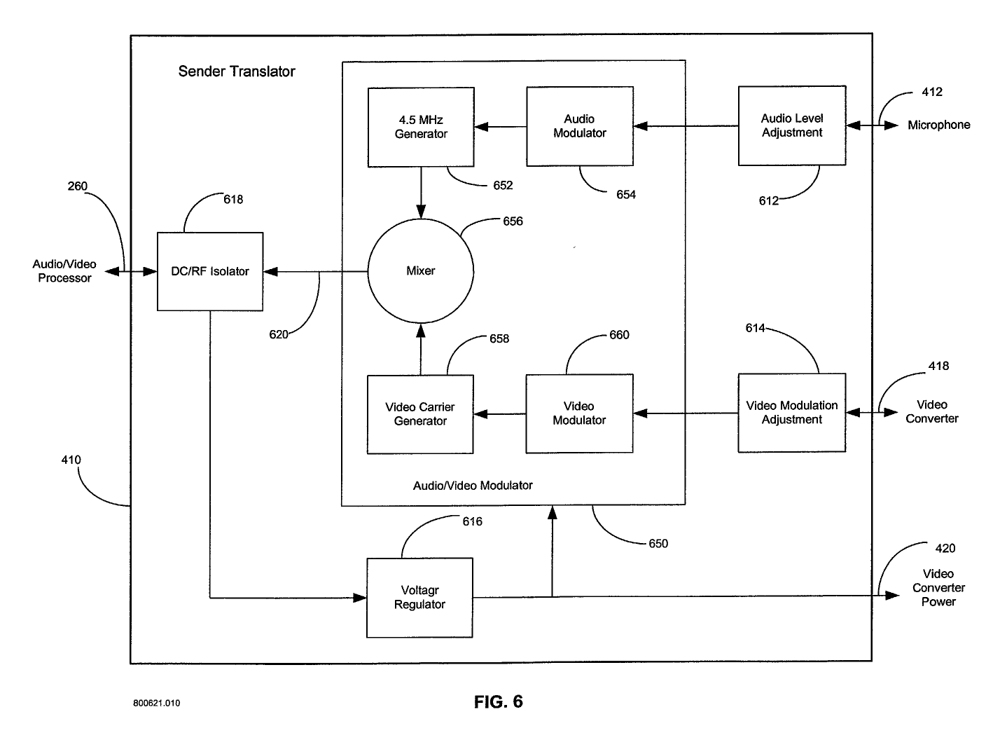

Turning now to FIG. 6, FIG. 6 shows an embodiment of a sender translator 410 used in a camera according to the present invention. The sender translator 410 is located in a camera, and receives audio signals from a microphone 412 and video signals from a video converter 418. The sender translator 410 transmits a radio frequency carrier over a coaxial cable to an audio/video processor 260 that is amplitude modulated by the video signal 418 and frequency modulated by the audio signal 412. The sender translator 410 makes use of an audio/video modulator integrated circuit 650 to modulate the audio signal 412 and the video signal 418. The audio signal from the microphone 412 is passed through an audio level adjustment means 612 to an audio (frequency) modulator 654 that controls a 4.5 MHz signal generator 652. The frequency modulated audio signal from the generator 652 is mixed in a mixer 656 with a carrier signal that is amplitude modulated by the video signal and sent to a DC/RF isolator 618 which further transmits the modulated signal 260 over a coaxial cable to an Audio/video processor. The video signal 418 is sent to a video modulator 660 that modulates a video carrier generator 658. The (amplitude) modulated video signal is then mixed with the frequency modulated audio signal in the mixer 656 as described above. The DC power on the coaxial cable 260 is passed through the DC/RF isolator 618 that provides a low impedance path for the DC power and a high impedance path for the modulated carrier to a voltage regulator 616. Similarly, the DC/RF isolator 618 presents a low impedance path for the modulated carrier between the mixer and the coaxial cable 260, and a high impedance path for the modulated carrier between the mixer 656 and the voltage regulator 616. The output of the voltage regulator 616 provides power to the audio/video modulator and to the video converter 420.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A method for transferring audio and video signals and power between a remote source and a central processor over a single coaxial cable in an audio/video security system, comprising:
modulating a carrier signal with an audio signal and a video signal in a camera at a remote location;
transmitting the carrier signal on the single coaxial cable to an audio/video processor located at a central control location;
receiving and demodulating the carrier signal into an audio component and a video component in the audio/video processor for display and acoustic monitoring;
transmitting power from the audio/video processor to the remotely located camera over the single coaxial cable; and
receiving and regulating the power in the remotely located camera for powering electronic components within the remotely located camera.

2. The method of claim 1, wherein the steps of transmitting the carrier signal and transmitting power over the single coaxial cable are conducted simultaneously.

3. The method of claim 1, further comprising:
combining the power and the modulated carrier in the audio/video processor; and
splitting the power and the modulated carrier in the remotely located camera.

4. The method of claim 1, further comprising displaying the video component on a video monitor and annunciating the audio component on a speaker.

5. The method of claim 1, wherein:
the step of receiving and demodulating the carrier signal comprises receiving and demodulating a plurality of carrier signals into a plurality of audio components and a plurality of video components in the audio/video processor for display and acoustic monitoring; and
the step of transmitting power from the audio/video processor comprises transmitting power from the audio/video processor to a plurality of remotely located cameras over a plurality of single coaxial cables whereby a single coaxial cable is connected to each camera.

6. The method of claim 5, further comprising displaying the plurality of video components sequentially on a video monitor and annunciating the plurality of audio components sequentially on a speaker.

7. The method of claim 5, further comprising displaying the plurality of video components simultaneously on a video monitor and annunciating the plurality of audio components simultaneously on a speaker.

8. The method of claim 1, further comprising selecting the power in the remotely located camera from a remotely located power supply positioned near the camera.

9. The method of claim 5, further comprising selectively disabling transmitting power from the audio/video processor to selected cameras.

10. The method of claim 1, wherein the video signal represents a black and white image.

11. The method of claim 1, wherein the video signal represents a color image.

12. The method of claim 1, wherein:
the step of modulating a carrier signal comprises modulating a carrier signal with a video signal in a camera at a remote location; and
the step of receiving and demodulating the carrier signal comprises receiving and demodulating the carrier signal into a video component in the audio/video processor for display monitoring.

13. The method of claim 5, further comprising:
selecting a remotely located camera having a standard video signal output connected to the audio/video processor and an associated remotely located power supply;
disabling the transmitting power from the audio/video processor to the selected remotely located camera over the single coaxial cable; and
receiving the standard video signal from the selected remotely located camera by the audio/video processor for display monitoring.

14. A system for transferring audio and video signals and power between a remote source and a central processor over a single coaxial cable in an audio/video security system, comprising:
means for modulating a carrier signal with an audio signal and a video signal in a camera at a remote location;
means for transmitting the carrier signal on the single coaxial cable to an audio/video processor located at a central control location;
means for receiving and demodulating the carrier signal into an audio component and a video component in the audio/video processor for display and acoustic monitoring;
means for transmitting power from the audio/video processor to the remotely located camera over the single coaxial cable; and
means for receiving and regulating the power in the remotely located camera for powering electronic components within the remotely located camera.

15. The system of claim 14, wherein the means for modulating a carrier signal comprises an audio/video modulator for amplitude modulating the carrier signal with the video signal and frequency modulating the carrier signal with the audio signal.

16. The system of claim 14, wherein the means for demodulating the carrier signal comprises an audio/video demodulator for amplitude demodulating the carrier signal for obtaining the audio component and frequency demodulating the carrier signal for obtaining the video component.

17. The system of claim 14, further comprising means for combining the power and the modulated carrier in the audio/video processor and means for splitting the power and the modulated carrier in the remotely located camera.

18. The system of claim 14, wherein:
the means for receiving and demodulating the carrier signal comprises means for receiving and demodulating a plurality of carrier signals into a plurality of audio components and a plurality of video components in the audio/video processor for display and acoustic monitoring; and
the means for transmitting power from the audio/video processor comprises means for transmitting power from the audio/video processor to a plurality of remotely located cameras over a plurality of single coaxial cables whereby a single coaxial cable is connected to each camera.

19. The systems of claim 14, further comprising a switch in the remotely located camera for selecting the power from a remotely located power supply positioned near the camera.

20. The system of claim 14, wherein:
the means for modulating a carrier signal comprises modulating a carrier signal with a video signal in a camera at a remote location; and
the means for receiving and demodulating the carrier signal comprises receiving and demodulating the carrier signal into a video component in the audio/video processor for display monitoring.

21. The system of claim 18, further comprising:
a plurality of switches in the audio/video processor for selecting a remotely located camera having a standard video signal output connected to the audio/video processor and an associated remotely located power supply;
means for disabling the transmitting power from the audio/video processor to the selected remotely located camera over the single coaxial cable; and
means for receiving the standard video signal from the selected remotely located camera by the audio/video processor for display monitoring.

22. A system for transferring audio and video signals and power between a remote source and a central processor over a single coaxial cable in an audio/video security system, comprising:
a plurality of remotely located cameras, each camera connected by a single coaxial cable to an audio/video processor at a central control location;
a plurality of remotely located microphones, each microphone positioned in close proximity to and electrically connected to a remotely located camera; and
the audio/video processor connected to a video monitor and a speaker, in addition to being connected to each of the plurality of cameras by a single coaxial cable.

23. The system of claim 22, wherein each camera comprises:
a video converter connected to a sender translator video input by a video connection and to a sender translator by a power connection through a switch;
an external power supply connector connected to the switch;
an external microphone connector connected to the sender translator microphone input; and
a coaxial cable connector connected to the sender translator.

24. The system of claim 22, wherein the audio/video processor comprises:
a plurality of coaxial connectors connected to a plurality of receiver translators;
an audio output from each receiver translator connected to processing circuitry;
a video output from each receiver translator connected to the processing circuitry;
a power supply connected to the processing circuitry, the receiver translators, and to switches connected to the receiver translators for selectively disabling power transmission to remotely located cameras and enabling standard video signals from the selected cameras to be accepted by the processing circuitry;
a video monitor connector connected to the processing circuitry; and
an audio speaker connector connected to the processing circuitry.

25. The system of claim 23, wherein the sender translator comprises:
an audio level adjustment connected between the microphone input and an audio modulator input of an audio/video modulator;
a video modulation adjustment connected between the video converter input and a video modulator input of the audio/video modulator;
a voltage regulator with input connected to a splitter power output and output connected to the audio/video modulator and a video converter power connection; and
the splitter connected to a coaxial cable connector for connecting to an audio/video processor, the splitter power output connection connected to the voltage regulator, and the splitter carrier signal input connected to a mixer output of the audio/video modulator.

26. The system of claim 25, wherein the audio/video modulator comprises:
the audio modulator input connected to the audio level adjustment and an audio modulator output connected to a frequency generator;
a frequency generator output connected to a mixer audio input;
the video modulator input connected to the video modulation adjustment and a video modulator output connected to an input of a video carrier generator;
a video carrier generator output connected to a mixer video input; and
the mixer output connected to the splitter.

27. The system of claim 24, wherein each of the receiver translators comprises:
a connection between a coaxial cable connector and a combiner camera input;
a power input connection between a power input connector, a voltage regulator input and a combiner power input;
a voltage regulator output connected to an audio/video demodulator;
a filter input connected to a combiner carrier signal output;
a filter output connected to an input of an IF amplifier of the audio/video demodulator;
an audio output driver having an input connected to the output of a sound detector of the audio/video demodulator and an output connected to an audio processing circuitry output; and
a video output driver having an input connected to a video output of a video amplifier of the audio/video demodulator and an output connected to a video processing circuitry output.

28. The system of claim 27, wherein the audio/video demodulator comprises:
an IF amplifier having the input connected to the filter output and an output connected to an input of a video demodulator;
an output of the video demodulator connected to an input of the video amplifier;
the video output of the video amplifier connected to the input of the video output driver and an audio output of the video amplifier connected to an input of an IF filter;
an output of the IF filter connected to an input of a sound IF amplifier; and
an output of the sound IF amplifier connected to the sound detector whose output is connected to the input of the audio output driver.

29. The system of claim 24, wherein the processing circuitry generates a video monitor signal that is sent to the video monitor for sequential display of images from the plurality of cameras, and generates an audio speaker signal that is sent to the speaker for sequential annunciation of sound from the plurality of microphones synchronized with the monitor displayed images.

30. The system of claim 24, wherein the processing circuitry generates a video monitor signal that is sent to the video monitor for simultaneous display of images from the plurality of cameras, and generates an audio speaker signal that is sent to the speaker for selected annunciation of sound from one of the plurality of microphones.
